(19) United States
(12) Patent Application Publication
(10) Pub. No.: US 2026/0132901 A1
(43) Pub. Date: May 14, 2026

(54) Vehicle Lighting Device, Motor Vehicle and Method for Producing a Vehicle Lighting Device

(71) Applicant: Bayerische Motoren Werke Aktiengesellschaft, Muenchen (DE)

(72) Inventor: Andreas LANG, Groebenzell (DE)

(21) Appl. No.: 19/118,060

(22) PCT Filed: Dec. 11, 2023
(86) PCT No.: PCT/EP2023/085015

§ 371 Date: Apr. 3, 2025

(30) Foreign Application Priority Data
Jan. 12, 2023 (DE) 10 2023 100 627.4

(51) Int. Cl. F21S 41/20; F21S 41/24; F21S 41/29

(52) U.S. Cl. CPC F21S 41/2805; F21S 41/24; F21S 41/29

(57) ABSTRACT

A vehicle lighting device includes a housing having a first housing part and a second housing part, and a closure plate unit having a one-piece closure plate which has a first region, which is transparent at least in sections, and a second region. The first housing part defines a first inner region, which is covered by the first region of the closure plate, and the second housing part defines a second inner region, which is covered by the second region of the closure plate. The closure plate unit has a predetermined breaking point at a boundary between the first region of the closure plate and the second region of the closure plate.

### BACKGROUND AND SUMMARY

The present invention relates to a vehicle lighting device, to a motor vehicle comprising the vehicle lighting device and to a method for producing the vehicle lighting device.

Known motor vehicles, in particular land vehicles, usually contain front lamps, tail lamps and side lamps, which are part of the overall motor vehicle lighting system. Such motor vehicle lamps are primarily used for better driver's vision in darkness and better visibility of the motor vehicle per se and may be variously equipped, in particular according to a characteristic light signature for the vehicle in question.

A motor vehicle lamp known from the prior art is disclosed in the document DE 10 2004 028 970A1 . The lamp is formed as a signal lamp and consists essentially of a light guide element, a light source and a coating. The light guide element has a light exit face arranged on its front side in the emission direction and a reflection face on its rear side. The light coupled into the light guide element through a light input coupling face is forwarded in the light guide element by way of total internal reflection, light incident on the reflection face being deviated toward the light exit face and emerging from the latter in the emission direction.

Against this background, it is an object of the present invention to provide a vehicle lighting device that can be produced relatively simply and economically with a comparatively large closure plate but can nevertheless comply with stringent pedestrian protection requirements. In addition, it is an object of the invention to provide a corresponding motor vehicle and a corresponding method for producing the vehicle lighting device.

These objects are achieved by a vehicle lighting device, by a motor vehicle, and by a method according to the claimed invention.

The vehicle lighting device may be formed as a motor vehicle lamp, in particular front lamp, and comprises a housing with a first housing part and a second housing part, and a closure plate unit with a one-piece closure plate which has an at least in portions optically transmissive first region and a second region. The first housing part defines a first inner region, which is covered by the first region of the closure plate, and the second housing part defines a second inner region, which is covered by the second region of the closure plate. At a boundary between the first region of the closure plate and the second region of the closure plate, the closure plate unit has a premade break point.

This arrangement of the premade break point allows the closure plate to be configured comparatively large in order to cover large lamp compartments, and at the same time to provide a vehicle lighting device that is advantageous in respect of pedestrian safety. In particular, in the event of an accident with a pedestrian in which the pedestrian collides with the first or second region of the closure plate, the closure plate can break at the aforementioned boundary so that the first region of the closure plate is mobile relatively freely, in particular being detached from the second region of the closure plate. The notch impact strength of the closure plate is reduced. This results in lower maximum forces acting on the pedestrian and a lower risk of injury for the pedestrian.

The terms front/front-side/front side and rear/rear-side/rear side as used here may refer to the preferred installation position of the vehicle lighting device. That is to say, the closure plate may preferably be arranged on the front side and the housing may preferably be arranged on the rear side.

In the context of the present disclosure, the term “at the boundary” (between the first and second regions of the closure plate) refers to a location adjacent to this boundary. The position of the premade break point defines the boundary. That is to say, when the premade break point is formed (at least partially) in the closure plate, the boundary may run through the premade break point. When the premade break point is formed in another constituent part of the closure plate unit, on the other hand, in particular the supporting structure described below, a distance between the premade break point and the first region may correspond substantially to a distance between the premade break point and the second region.

The term premade break point refers according to its general definition in the field of automotive technology to a point determined by a predetermined structure, configuration and/or design (for example material narrowing) that breaks predictably under a predetermined load. In particular, the premade break point may be configured to break when a predetermined relative load between the first and second regions of the closure plate is exceeded, so that the first region is detached from the second region. That is to say, a premade break point may describe that part of the overall vehicle lighting device, or of the closure plate unit, which breaks first when the first region is for example pulled away from the second region parallel to a main face of the closure plate, for instance in a predetermined tensile test.

In addition to the closure plate, the closure plate unit may have a supporting structure, which may be arranged between the housing and the closure plate. Preferentially, the supporting structure and the closure plate together form the closure plate unit in the sense of the present disclosure. The premade break point may be formed partially or fully in the supporting structure. Furthermore, the premade break point may be formed partially or fully in the closure plate. In one preferred variant, the premade break point is formed as explained in more detail below both in the supporting structure and in the closure plate.

The supporting structure may mechanically connect the housing to the closure plate. In particular, the supporting structure may have a first connecting portion, which contacts the first region of the closure plate and by way of which the first housing part is connected to the first region of the closure plate. In a similar way to this, the supporting structure may have a second connecting portion, which contacts the second region of the closure plate and by way of which the second housing part is connected to the second region of the closure plate. The supporting structure is preferably materially bonded to the housing and/or to the closure plate, most preferably injection-molded (that is to say joined by way of injection molding) onto the closure plate and/or adhesively bonded or welded to the housing. A (rear-side) end of the supporting structure, opposite to the closure plate, may be received in at least one groove formed in the housing and preferably running along a circumference of the first housing part, or respectively the second housing part.

The first housing part is preferentially formed separately from the second housing part and/or spaced apart from the second housing part. The first region of the closure plate may, together with the first housing part and the first connecting portion, form a first lamp compartment of the vehicle lighting device, which can be sealed outward by the closure plate. In a similar way to this and separately therefrom, the second region of the closure plate together with the second housing part and the second connecting portion may form a second lamp compartment of the vehicle lighting device. Preferably, the first lamp compartment is formed separately from the second lamp compartment and/or is larger than the second lamp compartment. Instead of the second lamp compartment, a partial housing for one or more environment sensors of the motor vehicle may correspondingly be formed by the second region, the second housing part and the second connecting portion. The first housing part and the second housing part may be connected firmly to one another exclusively via the closure plate unit, in particular via the closure plate. That is to say, the first housing part can be decoupled from the second housing part when the closure plate unit breaks at the premade break point.

Preferably, the supporting structure protrudes from the closure plate on the rear side. Adjacent to the aforementioned boundary between the first and second regions of the closure plate, the first and/or second connecting portion (as viewed in a cross-sectional plane running perpendicularly to the main face) may be formed substantially in an L-shape, respective short branches of the first or second connecting portion preferentially contacting the closure plate (directly or indirectly). These short branches may together form a rigidifying layer of the vehicle lighting device. If the premade break point is (also) formed in the supporting structure, it may preferentially be located in the rigidifying layer.

The premade break point is preferably formed as a material thinning or wall thickness discontinuity in the closure plate and/or in the supporting structure, particularly in the rigidifying layer. Such a premade break point may be produced comparatively simply and efficiently during the production of the closure plate unit by way of injection molding, by the injection molding tool being correspondingly contoured. Most preferably, the premade break point is formed by way of a notch in the rigidifying layer and/or the closure plate. In other words, the premade break point may be formed as a notch that narrows in the direction of an outer surface of the closure plate opposite to the housing.

On the outer surface (that is to say on the outside/front side), the closure plate is preferably formed seamlessly (at least at the boundary between the first region and the second region). In particular, the closure plate can have a joint-free layer on the outside, which forms a lens at least in the first region. The inner regions can therefore be protected better against environmental influences. Further, the vehicle lighting device can in this way be integrated better into the vehicle. The closure plate with these features may be produced rapidly and economically if the entire closure plate unit, including the closure plate and optionally the supporting structure, or at least the closure plate is produced as a molded part (a so-called multicomponent molded part), preferably a plastic molded part. The joint-free layer may in this case be formed monolithically (from a first material). Further, the supporting structure may be formed monolithically (from a second material). The first material and/or the second material may be a polymer, in particular polycarbonate (PC). The first material may alternatively be polymethyl methacrylate (PMMA).

In order to form the first lamp compartment, it is further preferential that the first region of the closure plate is transparent. Accordingly, a lighting device may be provided in the first lamp compartment in order to provide a front lamp, for example, in particular a headlamp and/or a daytime running lamp, in the first lamp compartment. The second region of the closure plate, on the other hand, is preferably optically nontransmissive, opaque or translucent so that the content of the second inner region can be concealed by the closure plate. At least one environment sensor, in particular a radar sensor or a LIDAR sensor, may for example be accommodated in this second inner region without being visible from the outside. In order to achieve this concealment, the first and/or second region of the closure plate may be provided with an at least in portions optically nontransmissive or translucent film (a so-called decorative film). The film may likewise be produced from a polymer (in particular polycarbonate) in order to achieve a high radar transparency.

In a further variant, the closure plate may have a light guide. The light guide may, in particular, be formed as a two-dimensional light guide. It may furthermore extend over the first and/or the second region of the closure plate. Preferably, the light guide is adapted to couple light propagating through the light guide out in such a way that it emerges at a light exit face of the closure plate in the direction of the surroundings of the vehicle lighting device. The light guide is preferentially formed between the joint-free layer and the housing. If the film is provided, the light guide may preferentially be formed on the rear side (directly or indirectly) on the film and therefore between the film and the housing. By way of the light guide, the film can therefore be backlit comparatively homogeneously. If the film extends over the first and second regions, the light guide may preferentially likewise extend over the first and second regions. If the film is formed only on the first or the second region, on the other hand, the light guide may preferentially likewise be formed only (indirectly) on the first or the second region, respectively.

If the supporting structure is present, it may be formed on the rear-side surface of the closure plate. That is to say, if the light guide forms the rear-side surface of the closure plate, the vehicle lighting device may be produced particularly simply when the first and/or second connecting portion contacts the light guide on the rear side, and in particular is injection-molded onto the light guide on the rear side. This applies correspondingly for the aforementioned film and for an optional additional reflection layer on the side of the light guide facing toward the housing. This reflection layer may be regarded as part of the light guide; that is to say, the comments made concerning the light guide may apply correspondingly for the reflection layer. Further, the light guide may be provided with (for example optically refracting or optically scattering) coupling optics (for example prisms) in order to couple the light out as described above. In order to couple the light into the light guide, the vehicle lighting device may have an additional light source. This light source may be arranged in the first and/or in the second inner region and therefore be protected against weathering influences.

In this further variant, the premade break point may be formed adjacent to the boundary in the rigidifying layer, in the light guide (optionally including the reflection layer), in the film and/or in the joint-free layer, in particular as the notch or another type of material narrowing or as a recess in at least one of these components. A vehicle lighting device having these features can be produced simply and efficiently. The premade break point may in this case be formed off-tool during the injection-molding process.

The motor vehicle proposed here comprises at least one vehicle lighting device as described above. Preferably, the vehicle lighting device is formed as a front lamp. In particular, the vehicle lighting device may in its installation position (in relation to the vehicle longitudinal axis) be wider than one fourth, preferentially wider than one third of the vehicle width. The closure plate may, as viewed from the front, preferentially extend substantially (to within up to 15%) over half of the vehicle width, preferably from the middle of the vehicle to the side wall in the transverse direction of the vehicle. Preferably, the vehicle lighting device is mounted on the motor vehicle in such a way that the first region of the closure plate lies horizontally next to the second region of the closure plate as viewed from the front. The second region of the closure plate is preferably arranged closer than the first region to the vehicle longitudinal axis.

The production method proposed here is used to produce the vehicle lighting device as described above and comprises an injection-molding process in which the premade break point is formed off-tool. The injection-molding process may be a so-called multicomponent injection molding process, in which the closure plate may be formed as a first component with a first molding compound and the supporting structure may be formed as a second component with a second molding compound, which is injection-molded separately from the first molding compound.

The injection-molding process may in particular contain the following steps, which are preferably carried out in the order explained below: injection-molding the first molding compound into a cavity of the first injection-molding tool in order to form at least the joint-free layer of the closure plate (as a first component). The joint-free layer may then be provided in a cavity of a second injection-molding tool. A second molding compound may be injection-molded into the cavity of the second injection molding tool, in which case the supporting structure described in detail above may be formed. Following the injection-molding process, the housing with the first housing part and the second housing part may be fastened to the supporting structure.

In order to produce the vehicle lighting device with the optically nontransmissive or translucent film, this film may be placed as an insert into the cavity of the first injection-molding tool before the injection molding of the first molding compound. The joint-free layer is preferably injection-molded directly onto the insert. As an alternative to the joint-free layer or in addition thereto, the light guide may be injection-molded on a side of the film opposite to the joint-free layer. The combination of a light guide, film and joint-free layer may be formed particularly advantageously by placing the film as an insert into the cavity of a third injection-molding tool, in which the light guide is injection-molded onto the film on the rear side. A first tool half of the third injection-molding tool may then be replaced with a first tool half of the first injection-molding tool. The first and the third injection-molding tools may use the same second tool half, so that the injection-molded part (film with light guide) may at least in portions remain in the second tool half during the replacement. Following this, the injection-molded part may thus be located in the first injection-molding tool in which, as described, the joint-free layer is formed.

The motor vehicle and the method may have any, in particular all, features of the vehicle lighting device.

Preferred embodiments of a vehicle lighting device, of a motor vehicle and of a method for producing the vehicle lighting device are now explained in more detail with reference to the appended schematic drawings.

### BRIEF DESCRIPTION OF THE DRAWINGS

FIG. 1 shows one variant of a vehicle lighting device in a sectional view, a film being formed in a second region of the closure plate.

FIG. 2 shows a further variant of a vehicle lighting device in a sectional view, a film and a light guide being formed in a second region of the closure plate.

FIG. 3 shows a further variant of a vehicle lighting device in a sectional view, a film and a light guide being formed in a first and the second region of the closure plate.

FIG. 4 shows a further variant of a vehicle lighting device in a sectional view, a reflection layer being formed on the rear side on the light guide.

FIG. 5 shows a motor vehicle with a viewing direction from the front.

FIG. 6 shows a method for producing a vehicle lighting device.

FIGS. 7a to 7d show intermediate states of the vehicle lighting device during production according to the method of FIG. 6.

### DETAILED DESCRIPTION OF THE DRAWINGS

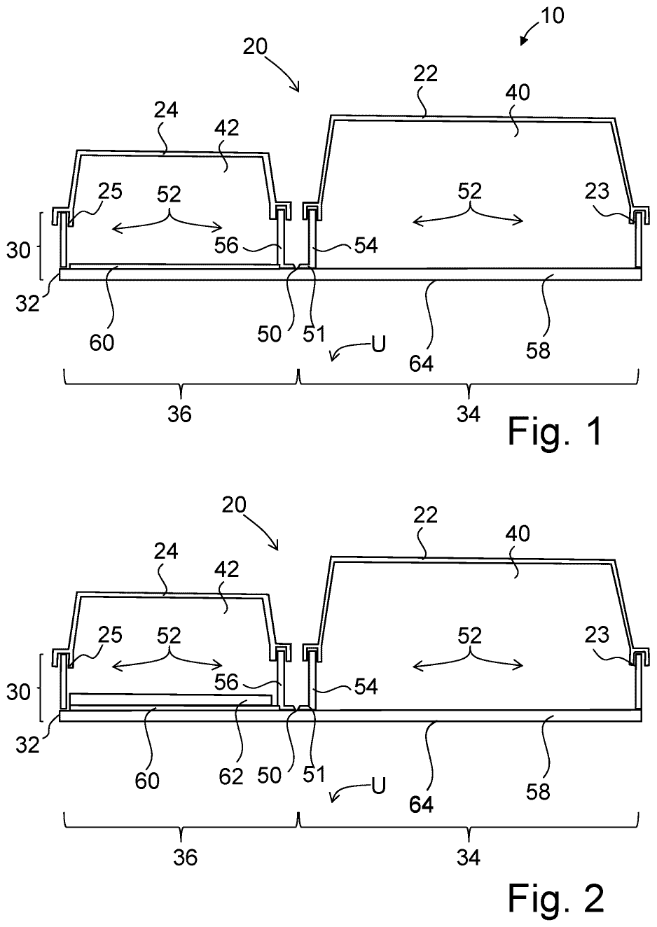

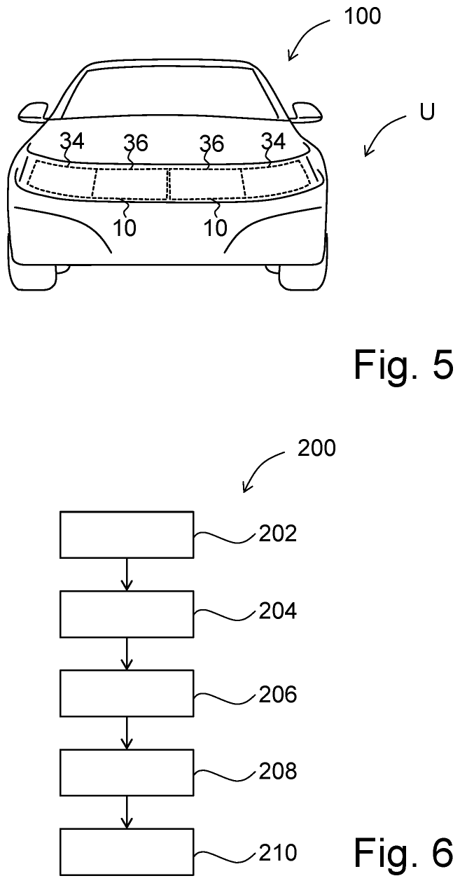

FIG. 1 shows a vehicle lighting device 10 for a motor vehicle 100 of FIG. 5. A front side of the vehicle lighting device with a light exit face is arranged below in FIG. 1 and a rear side is arranged above in FIG. 1. The vehicle lighting device 10 is in the present case a front lamp of the motor vehicle 100. The vehicle lighting device 10 comprises a housing 20 and a closure plate unit 30 that seals the housing 20. The housing 20 has a first housing part 22 and a second housing part 24, which is separate from the first housing part 22.

The first housing part 22 and/or the second housing part 24 are configured, as represented in FIG. 1, substantially in the shape of a half-shell and are open toward a closure plate 32 of the closure plate unit 30. By virtue of this shape, the first housing part 22 defines a first inner region 40 covered by the first region 34 of the closure plate 32 and the second housing part 24 defines a second inner region 42 covered by the second region 36 of the closure plate 32. A groove 23, 25 respectively runs along a front-side edge of the first or second housing part 22, 24, which faces toward the closure plate 32, by way of which the first and second housing parts 22, 24 are each connected firmly to the closure plate unit 30. The first housing part 22 and the second housing part 24 are spaced apart from one another and connected firmly (in particular not nondestructively detachably) to one another preferentially only via the closure plate unit 30, most preferably only via the closure plate 32.

The closure plate unit 30 is formed as a plastic molded part, in particular as a multicomponent injection-molded part. This (injection-)molded part may comprise as components the one-piece closure plate 32 as well as a supporting structure 52 between the housing 20 and the closure plate 32. The supporting structure 52 is therefore injection-molded at its front side onto the closure plate 32. The supporting structure 52 may further be in engagement on the rear side with the grooves 23, 25, in particular materially bonded therein to the housing 20. The closure plate 32 has an at least in portions optically transmissive first region 34 as well as a second region 36. At a boundary between the first region 34 of the closure plate 32 and the second region 36 of the closure plate 32, a premade break point 50 is formed as part of the closure plate unit 30. In particular, the supporting structure 52 in the present case comprises a rigidifying layer 51, which is formed in portions on the first region 34 and in portions (on the rear side; i.e. above in FIG. 1) on the second region 36. In this rigidifying layer 51, the premade break point 50 is formed as a material narrowing (indentation on the rear side of the closure plate 32). The premade break point 50 may preferentially be formed as a notch that narrows in the direction of an outer surface 64 of the closure plate 32 opposite to the housing 20.

In the transverse direction (parallel to the main face of the closure plate 32), the premade break point 50 is located as shown in FIG. 1 at the boundary between the first region 34 and the second region 36. Optionally, the premade break point 50/indentation may extend into the closure plate 32. That is to say, the premade break point 50 may be formed at least partially (also) in the closure plate 32. While the supporting structure 52 is notched, the closure plate 32 may form a joint-free layer 58 at least on the outside (below in FIG. 1). FIG. 1 furthermore shows that the outer surface 64 of the closure plate 32 opposite to the housing 20 is formed seamlessly, particularly in the region of the boundary. Preferentially, this outer surface 64 is completely seamless. The joint-free layer 58 forms a lens preferably at least in the first region 34, and optionally also in the second region 36. Advantageously, the vehicle lighting device 10 can therefore be integrated relatively easily on the exterior of the vehicle.

The supporting structure 52 comprises a plurality of connecting portions, by way of which (preferably exclusively) the housing 20 is coupled to the closure plate 32. A first connecting portion 54 extends from the first region 34 of the closure plate 32 as far as the first housing part 22, as well as transversely with respect to the closure plate 32. A second connecting portion 56 separate from the first connecting portion 54 extends from the second region 36 of the closure plate 32 as far as the second housing part 24, as well as transversely with respect to the closure plate 32. The first and second connecting portions 54, 56 run substantially parallel to one another and are formed monolithically (“from one block”, without joints) with the rigidifying layer 51.

In respect of the optical properties of the closure plate unit 30, the closure plate 32 is distinguished by transparency in the first region 34. The lamp compartment defined by the first housing part 22, the first connecting portion 54 and the first region 34 of the closure plate 32, with the first inner region 40, is therefore suitable for forming a front lamp. A light function may be implemented in this lamp compartment, for example as a headlamp, daytime running lamp and/or signal lamp. Correspondingly, the front lamp may have one or more light sources (not represented separately in the figures). The second compartment defined by the second housing part 24, the second connecting portion 56 and the second region 36 of the closure plate 32, with the second inner region 36, may be smaller than the aforementioned lamp compartment and/or may likewise be formed as a lamp compartment in order to form a (further) front lamp. A headlamp, a daytime running lamp and/or a signal lamp (as well as at least one associated light source) may likewise be provided in this further lamp compartment. In the variant of FIG. 1, on the other hand, the second region 36 of the closure plate 32 is optically nontransmissive, opaque or translucent so that the content of the second inner region is concealed. A motor-vehicle environment sensor (not shown), in particular a radar sensor, may advantageously be arranged in the second inner region 42. For the aforementioned purpose, the second region 36 of the closure plate 32 has an in portions or fully optically nontransmissive or translucent film 60, which here by way of example extends from the rigidifying layer 51 as far as a lateral edge of the closure plate 32. This film 60 is not formed in the first region 34 of the closure plate 32 in order to allow better light transmission.

A further variant, which is represented in FIG. 2, of the vehicle lighting device 10 differs from the vehicle lighting device 10 of FIG. 1 in that a light guide 62 (here a two-dimensional light guide) is formed on a side of the film 60 opposite to the outer surface 64 in order to backlight the second region 36. The film 60 is in this case preferably optically transmissive at least in portions. The light guide 62 may extend from a lateral connecting portion as far as the second connecting portion 56. The light guide 62 is adapted to couple light propagating through the light guide 62 out in such a way that it emerges at a light exit face of the closure plate 32 in the direction of the surroundings U of the vehicle lighting device 10. For this purpose, the light guide 62 may have corresponding output coupling optics. In the second inner region 42, a light source may be provided in order to couple the light into this light guide. In addition, the vehicle lighting device 10 of FIG. 2 has all features of the vehicle lighting device 10 of FIG. 1.

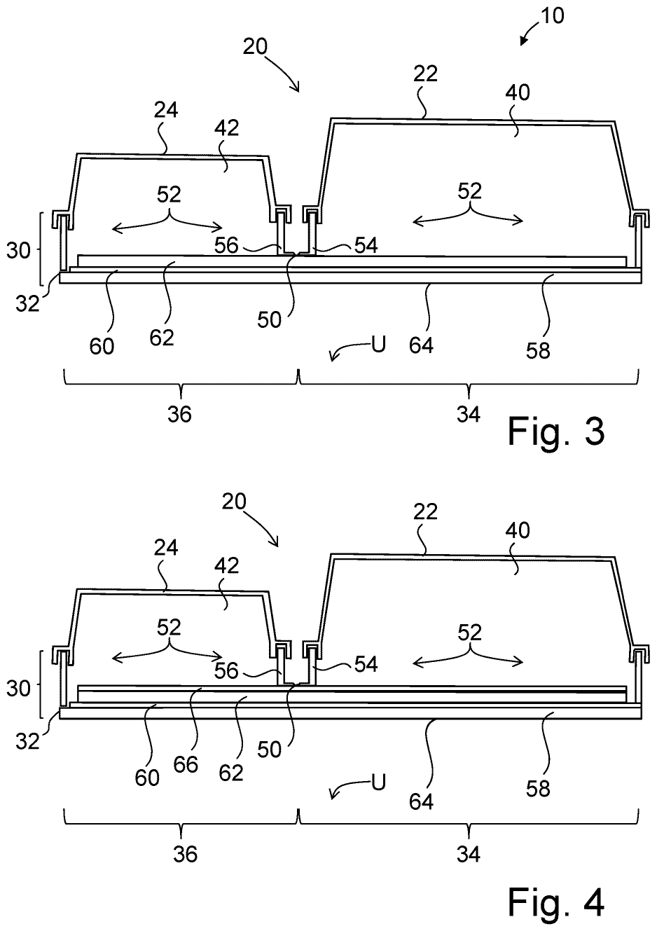

A further vehicle lighting device 10, which is represented in FIG. 3, differs from the vehicle lighting device 10 of FIG. 2 in that the film 60 and the light guide 62 are formed not only in the second region 36 but also in the first region 34 of the closure plate 32. As in the variant of FIG. 2, the closure plate 32 is formed in one piece. The film 60 and the light guide 62 are each joint-free and form layers of the multilayered closure plate 32. These layers are provided on the rear side on the joint-free layer 58. The supporting structure 52 contacts the light guide 62 on the inside/rear side at the premade break point 50. FIG. 4 in turn shows a further vehicle lighting device 10, which differs from the vehicle lighting device 10 of FIG. 3 in that this further vehicle lighting device has an additional reflection layer 66 (reflection film) on the rear side on the light guide 62. In addition, the vehicle lighting devices 10 of FIGS. 3 and 4 have all features of the vehicle lighting device 10 of FIG. 2.

The motor vehicle 100 shown in FIG. 5 with a viewing direction from the front here comprises by way of example two vehicle lighting devices 10 according to one of FIGS. 1 to 4, frontally arranged adjacent to one another (in particular at the front end of the vehicle, below a front hood). The vehicle lighting devices 10 are therefore used as front lamps. The two vehicle lighting devices 10 are arranged mirror-symmetrically with respect to one another (relative to the vehicle longitudinal axis of the motor vehicle 100), so that the first regions 34 of the closure plates 32 are respectively further away than the second regions 36 of the closure plates 32 from the vehicle longitudinal axis. The first regions 34 therefore preferentially form lenses through which the light can emerge from the light compartment thereby delimited into the surroundings U. At least one sensor of the motor vehicle 100 may be positioned behind the second regions 36. The at least one sensor may respectively be assigned at least one assistance system of the motor vehicle 100 in order to supply this assistance system with information relating to the environment, for example.

As an alternative or in addition thereto, a further light exit face may be formed in the second regions in order to further improve the visibility of the motor vehicle.

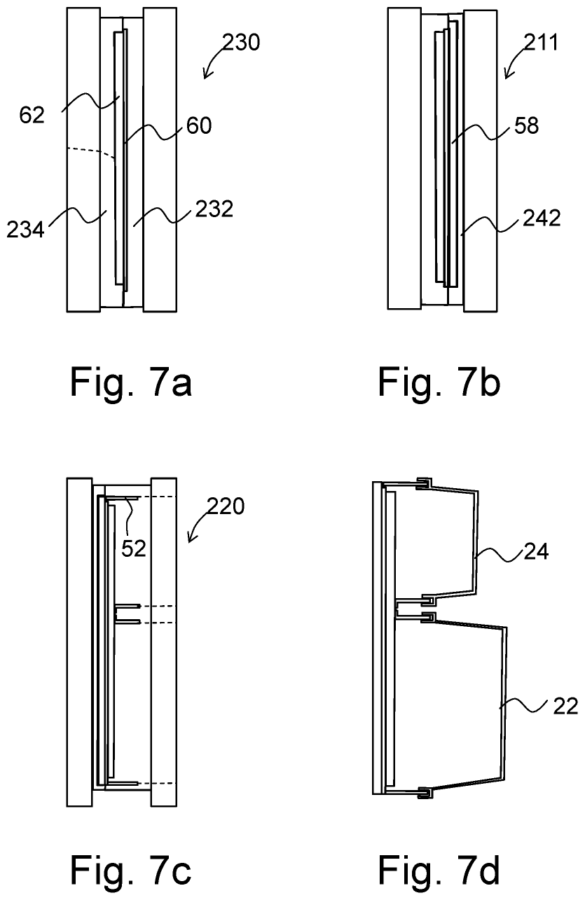

The method 200 represented in a very simplified way in FIG. 6 is used to produce the vehicle lighting device 10 of FIG. 3, although it may correspondingly also be used to produce one of the other vehicle lighting devices 10 described here. The method 200 comprises an injection-molding process with steps 202 to 208, as well as a fastening step 210 in which the housing 20 is fastened to the supporting structure 52. In the first step 202, the film 60 is provided as an insert in a third injection-molding tool 230 and the third injection-molding tool 230 is closed. Then, in step 204, a molding compound that forms the light guide 62 is injection-molded into the cavity of the third injection-molding tool 230 (see FIG. 7a). In the subsequent step 206, a first tool half 232 of the third injection-molding tool 230 is replaced with a first tool half 242, the film 60 together with the light guide 62 injection-molded thereon remaining in the second tool half 234. The first tool half 242 and the second tool half 234 together form a first injection-molding tool 211. Then, in step 206, a first molding compound is injection-molded into the cavity of the first injection-molding tool 211 in order to form at least the joint-free layer 58 of the closure plate 32 (see FIG. 7b). The joint-free layer 58 may then be provided in a cavity of a second injection molding tool 220. A second molding compound may be injection-molded in the subsequent step 208 into the cavity of the second injection-molding tool 220, in which case the supporting structure 52 including the premade break point 50 may be formed (“off-tool”) (cf. FIG. 7c). Following the injection-molding process, the housing 20 may be fastened, in particular adhesively bonded, in step 210 with the first housing part 22 and the second housing part 24 to the supporting structure (FIG. 7d).

The terms “comprising”, “having”, “with” and the like as used in this disclosure are not to be understood as exclusive. In particular, the term “comprising a/an” in this context means “comprising at least one”, that is to say “comprising a/an” does not exclude the possibility that further corresponding elements are present. The terms “first”, “second”, etc. serve merely as a list, without being indicative of any order. The term “substantially” may be understood as meaning within the scope of usual production tolerances (+/−10% of the value in question).

1.-12. (canceled)

13. A vehicle lighting device comprising:
a housing comprising a first housing part and a second housing part; and
a closure plate unit comprising a one-piece closure plate which has a first region, which is optically transmissive at least in sections, and a second region,
wherein the first housing part defines a first inner region covered by the first region of the closure plate and the second housing part defines a second inner region covered by the second region of the closure plate, and
wherein the closure plate unit has a premade break point at a boundary between the first region of the closure plate and the second region of the closure plate.

14. The vehicle lighting device according to claim 13,
wherein the closure plate unit has a supporting structure between the housing and the closure plate, and
wherein the premade break point is formed at least partially in the supporting structure.

15. The vehicle lighting device according to claim 13,
wherein the supporting structure is injection-molded onto the closure plate, and/or
wherein the supporting structure comprises a first connecting portion connecting the first region of the closure plate to the first housing part and a second connecting portion, which is separate from the first connecting portion, connecting the second region of the closure plate to the second housing part.

16. The vehicle lighting device according to claim 13,
wherein the premade break point is formed at least partially in the closure plate, and/or
wherein the closure plate is formed seamlessly on an outside at least at the boundary between the first region and the second region.

17. The vehicle lighting device according to claim 13,
wherein the premade break point is formed as a material thinning or wall thickness discontinuity, and/or
wherein the premade break point is formed as a notch that narrows in a direction of an outer surface of the closure plate opposite to the housing.

18. The vehicle lighting device according to claim 13,
wherein the closure plate unit or the closure plate is formed as a plastic molded part, and/or
wherein the closure plate has a joint-free layer on an outside, and the joint-free layer forms a lens at least in the first region.

19. The vehicle lighting device according to claim 13,
wherein the first region of the closure plate is transparent,
wherein the second region of the closure plate is optically nontransmissive, opaque or translucent, and/or
wherein the second region of the closure plate is provided with an, at least in portions, optically nontransmissive or translucent film.

20. The vehicle lighting device according to claim 13,
wherein the closure plate has a light guide, which is formed as a two-dimensional light guide, and
wherein the light guide is adapted to couple light propagating through the light guide out such that the light emerges at a light exit face of the closure plate in a direction of surroundings of the vehicle lighting device.

21. The vehicle lighting device according to claim 13,
wherein the closure plate unit has a supporting structure between the housing and the closure plate,
wherein the premade break point is formed at least partially in the supporting structure,
wherein the closure plate has a light guide, which is formed as a two-dimensional light guide,
wherein the light guide is adapted to couple light propagating through the light guide out such that the light emerges at a light exit face of the closure plate in a direction of surroundings of the vehicle lighting device, and
wherein the supporting structure contacts the light guide on an inside.

22. The vehicle lighting device according to claim 13,
wherein the first housing part and the second housing part are spaced apart from one another, and/or
wherein the first housing part and the second housing part are connected firmly to one another via the closure plate unit.

23. A motor vehicle comprising the vehicle lighting device according to claim 13,
wherein the vehicle lighting device is formed as a front lamp.

24. A method for producing the vehicle lighting device according to claim 13, the method comprising performing an injection-molding process in which the premade break point is formed off-tool.
